(19) United States
(12) Patent Application Publication
(10) Pub. No.: US 2014/0172692 A1
(43) Pub. Date: Jun. 19, 2014

(54) FLEXIBLE AUTOMATIC SAVINGS PROGRAMS

(71) Applicants: Jeanine Tabaczynski, Huntersville, NC (US); Shannon Conway, Charlotte, NC (US)

(72) Inventors: Jeanine Tabaczynski, Huntersville, NC (US); Shannon Conway, Charlotte, NC (US)

(73) Assignee: WELLS FARGO BANK, N.A., Charlotte, NC (US)

(21) Appl. No.: 14/098,108

(22) Filed: Dec. 5, 2013

Related U.S. Application Data
(63) Continuation of application No. 11/846,876, filed on Aug. 29, 2007.

(51) Int. Cl. G06Q 40/02; G06Q 20/10

(52) U.S. Cl. CPC G06Q 40/02; G06Q 20/10
USPC 705/39

(57) ABSTRACT

Flexible automatic savings programs and/or processes are provided in which a consumer is presented with multiple options for automatic savings to be applied to transactions, such that savings amounts are transferred from a first account to a second account automatically for qualified accounts and transactions. A financial institution can assist the consumer select one of the options to apply to automatic transfers. Transfer policy can thus be customized for a consumer according to their savings needs and goals. Participation is limited to common, or overlapping, ownership status with respect to both source and target accounts, though other ownership entities can also be present. The way that savings amounts are determined for automatic transfers can also be dynamically customized to savings characteristics or goals of the consumer as those characteristics or goals change.

### CROSS-REFERENCE TO RELATED APPLICATIONS

This application claims priority to and is a continuation of U.S. Non-Provisional patent application Ser. No. 11/846,876 (Attorney Docket No. 106750.7/WB2007013729) entitled “FLEXIBLE AUTOMATIC SAVINGS PROGRAMS”, filed on Aug. 29, 2007. The entirety of the above-noted application is incorporated by reference herein.

### TECHNICAL FIELD

The subject disclosure relates to automatic savings programs or processes implemented by financial institution(s) for automatically transferring funds, on behalf of an enrolled customer, from source financial account(s) to target financial account(s).

### BACKGROUND

At least in the United States, the rate of personal savings has declined steadily since 1980. Consumers have an inability or lack of discipline to save. By one measure, at any given moment today, the average U.S. household carries about $9,000 in credit card debt. In August 2006, for the first time in American history, the Federal Reserve reported that the average American consumer held more debt than income. A staggering and ever increasing figure, American consumer debt now totals over $2 trillion. While many different factors contribute to this dilemma, what is eminently clear is that the average American consumer is not saving enough money. Yet, consumers still have a desire to save more. As one of the largest unaddressed problems in American history, the ability to influence American savings habits in a positive direction, reversing these trends towards higher debt holdings, could hold enormous benefit for the economy as a whole.

As a result, some financial institutions and service businesses have set forth savings programs, which though limited, have encouraged consumers to save money for later. For instance, one conventional program implemented by gas stations, retail entities, etc. enables a customer of a gas station, for example, to obtain a credit card associated with the gas station and the customer's account. Then, when the customer pays for gas at a point of sale (POS) device, such as a credit card machine, the customer can set aside an additional payment for future gas, i.e., the customer can place additional credit, the amount being determined by the customer for each transaction, in the account for future use.

Such programs are limited because they require the customer, with respect to each transaction, to make an active choice of how much money to set aside. Additional administration and tracking of the transaction amounts by the retail entities is also required, creating additional burden on the gas station. Moreover, any additional monies credited to the customer's account begin to depreciate in value immediately due to inflationary forces and reduced interest while the money is deposited, or no interest during an interim delay prior to deposit. Thus, there is little incentive for the customer to perform such an act. In essence, while such programs divert more predictable dollars to such retail entities, such programs in reality do very little to help a consumer save more in the consumer's own name.

In other programs, in addition to applying future credit to the customer's account as part of a transaction, the consumer is allowed to transfer savings amounts to third parties who are independent of the consumer, creating transactional difficulties with respect to third party accounts not controlled by the implementing institution as well as potential trust and integrity issues with respect to the behavior of third parties not controlled by the financial institution.

For instance, if a customer at the gas station designates an amount of money that should automatically transfer to a charity account, there is little guarantee to the customer that the charity receives and utilizes the funds appropriately because the financial institution and the charity are not a closed loop. Such systems also require per transaction overhead at the POS device, such as a credit card machine of the retail store. Moreover, at bottom, unproven process designs and technology, i.e., the systems, software, and interfaces between merchants, networks and banks that together attempt to carry out these systems, causes doubts in consumers and adopters for such multi-party, error-prone and untrusted systems.

Another conventional program that has been implemented by a financial institution enables consumers to opt into a banking program that, for checking card purchases, rounds up transactions to the nearest whole dollar, diverting the round up amounts to a savings account pre-associated with the checking card account. In this regard, among other requirements, such program requires the customer to have, with the financial institution, a checking account with a check card and a savings account pre-associated with the checking account. While such conventional program may be a good start for helping consumers save additional dollars from fractional amounts of transactions over time, the consumer's choice ends with the opt in decision. The consumer may either participate or not participate for checking/check card/savings accounts meeting the participation criteria, but the consumer has no flexibility concerning how this happens.

Accordingly, a significant drawback of conventional savings programs is that they presume that each consumer has identical savings needs, and that those savings needs are deterministic as a predetermined criterion applied to everyone, such as “round up” on a per checking card transaction basis. In reality, the American consumer base possesses a diverse set of demographics with incomes, cultures and lifestyles that vary significantly from consumer to consumer. In an attempt to keep administrative costs low, among other reasons, conventional systems that offer automatic savings opportunities have thus imposed a fixed way of determining a savings amount that applies to every customer so enrolled in the program. Thus, such offerings fail to anticipate a desire for flexibility among different consumers and consumer oriented savings choices.

The above-described deficiencies of current designs for automatic savings programs are merely intended to provide an overview of some of the problems of today's systems, and are not intended to be exhaustive. Other problems with the state of the art and corresponding benefits of the invention may become further apparent upon review of the following description of various non-limiting embodiments of the invention.

### SUMMARY

Flexible automatic savings programs and/or processes are provided in which a consumer is presented with multiple options for automatic savings to be applied to transactions, such that savings amounts are transferred from a first account to a second account automatically for qualified accounts and transactions. A financial institution can assist the consumer select one of the options to apply to automatic transfers. Transfer policy can thus be customized for a consumer according to their savings needs and goals.

In one embodiment, a consumer has common, or overlapping, ownership status with respect to both source and target accounts though other ownership entities can also be named. In other embodiments, the way that savings amounts are determined for automatic transfers is dynamically customized to one or more savings characteristics or goals of the consumer as those characteristics or goals change over time.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

The flexible automatic savings programs of the invention are further described with reference to the accompanying drawings in which:

FIG. 1 is a block diagram illustrating embodiments of customized automatic savings in accordance with the invention;

FIG. 2 represents various embodiments of an automatic transfer of savings amounts in accordance with the invention;

FIG. 3 illustrates common ownership or overlap of ownership for automatic savings programs in accordance with the invention;

FIG. 4A illustrates an exemplary set of customer relationships in accordance with the invention;

FIG. 4B illustrates multiple transfer relationships for automatic savings in accordance with the invention;

FIG. 4C illustrates exemplary application of flexible transfer policy to a set of transactions for automatic savings in accordance with the invention;

FIG. 5 illustrates a set of options enabling flexible savings for different customers of an automatic savings program in accordance with the invention;

FIG. 6A illustrates exemplary selection from a set of savings program choices enabled in accordance with the invention;

FIG. 6B illustrates exemplary customization of a savings program based on savings characteristics of a customer in accordance with the invention;

FIG. 7 is an exemplary, non-limiting flow diagram showing enrollment in an automatic savings plan embodiments of the invention;

FIG. 8 is an exemplary, non-limiting flow diagram showing an accounting of the transaction transfers of the automatic savings plan embodiment of the invention;

FIG. 9A shows exemplary aspects of applying a premium benefit to a transferee account in accordance with an automatic savings program in accordance with the invention;

FIG. 9B is a flow diagram showing a non-limiting, optional method of administering a bonus program in connection with the various exemplary, non-limiting embodiments of the automatic savings plan of the invention;

FIGS. 10A, 10B and 10C are flow diagrams showing methods of enrolling and carrying out automatic transfers of savings amounts per transaction in various exemplary, non-limiting automatic savings plan embodiments of the invention;

FIG. 11 is a block diagram representing an exemplary non-limiting networked environment in which the present invention may be implemented; and

FIG. 12 is a block diagram representing an exemplary non-limiting computing system or operating environment in which the present invention may be implemented.

### DETAILED DESCRIPTION

### Overview

As discussed in the background, conventional programs for helping consumers to save money in an automatic manner have limitations that strip consumers of savings flexibility according to their individual savings needs. Often, for instance, consumers that need to save the most are the ones saving the least, and the ones that need to save the least are the ones that are saving the most. Accordingly, what is needed for consumers is flexibility for a savings program beyond mere “opt in” or “opt out” according to only one set of pre-fixed savings terms and conditions.

In consideration of these and other shortcomings of existing savings programs, in one non-limiting aspect of the invention, customers are empowered by an automatic savings program that is tailored to their savings characteristics and goals. Rather than impose a set of savings characteristics on all customers in the program, a customer can select a program or the financial institution can help select a program for the customer. The program can be tailored dynamically to the consumer's evolving saving goals and/or characteristics over time.

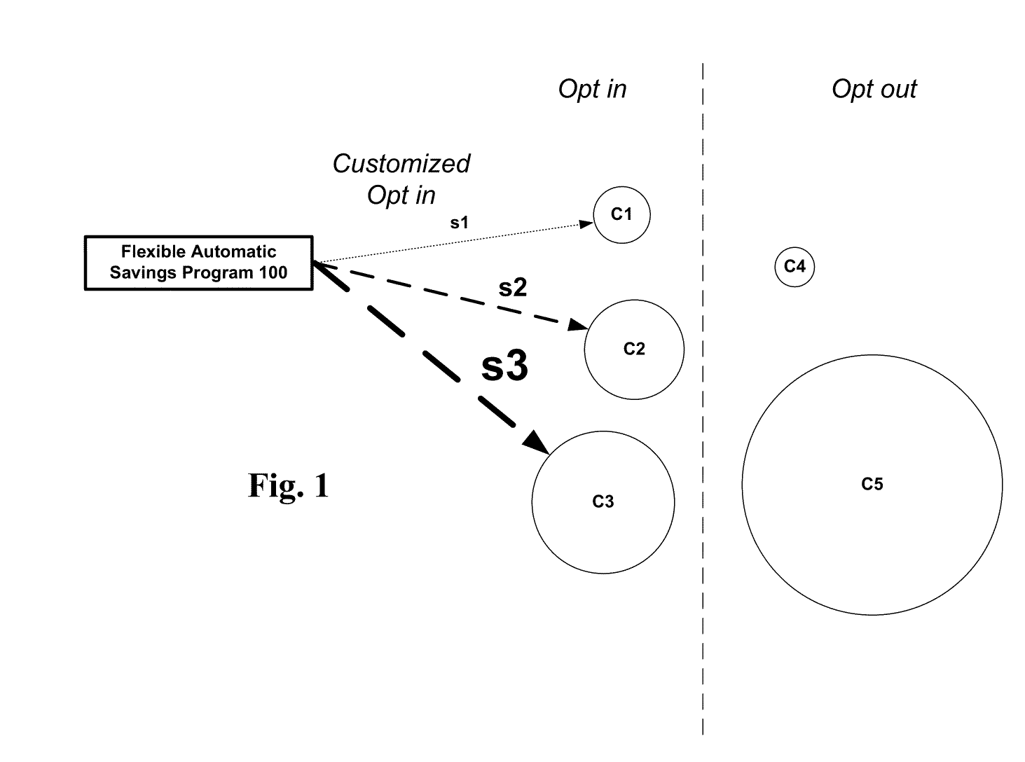

For instance, as generally illustrated in FIG. 1, in addition to being able to opt in or opt out of a savings program, customers C1, C2, C3 that opt in can tailor the savings program 100 to one or more their characteristics, e.g., personal, financial, etc. For instance, after opting into the program, customers C1, C2, C3 can specify a risk profile, a current overall level of savings, a current income, demographic information, a total amount of savings goal, etc., and have the automatic savings program determined for them as tailored to their characteristics. In other words, in one embodiment, a savings advisor helps the customer pick a savings program and amount s1, s2, s3, etc. that makes sense for the customer according to different options.

In another embodiment, a customer simply selects a savings program from a set of different savings programs, e.g., by comparing their features and projected savings over time, and selecting a program. With the additional automatic savings options, in general, customers are more likely to opt in than today due to the flexibility of automatic savings that can be tailored to the individual's savings needs.

Customer C5 in turn may opt out of the program because customer C5 may already have enough savings and customer C4 may opt out because customer C4 requires too much income to cover present expenses and saving extra is not feasible. Accordingly, one option is still not to participate in the savings program, providing an additional layer of savings flexibility.

In further non-limiting embodiments, the invention provides, or allows consumers to select, safeguards for automatic savings programs that operate to limit the ways in which savings can be added to and/or withdrawn from a transferee account, such as restricting certain kinds of transactions that result in savings for a transferee account or placing restrictions on withdrawal. Conversely, benefits can be provided for the transferee account, which are better than a typical savings account. Such benefits operate to incentivize a customer to keep savings in the account, or penalize withdrawal from the transferee account. For the avoidance of doubt, each of these features of the invention can be provided independent of one another, and are optional.

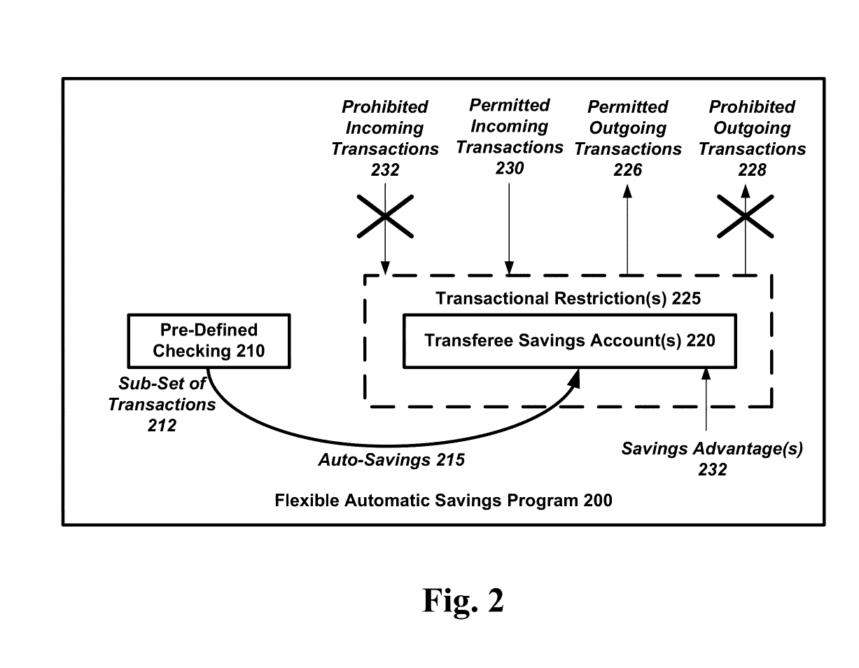

For instance, as shown in FIG. 2, a flexible automatic savings program 200 includes a checking account 210 in the program with at least one transfer relationship 215 to a target account, such as transferee account 220. The transferee savings account 220 can also include advantage(s) 232 that are not offered in connection with any other account. Such advantages include a higher interest rate, a bonus program by the financial institution, or the like. Where a bonus program is applied to the transferee savings account, the bonus amount from the financial institution, or third party willing to match, may also be dynamically tailored to the customer's savings needs. For instance, the financial institution can help kickstart savings for certain customers who have a lot of credit card debt, or otherwise tailor the bonus to the savings needs of the individuals.

As shown by sub-set of transactions 212 that trigger the automatic savings amount of the savings program of the invention, the financial institution also sets the kinds of transactions that will result in transfers 215. For instance, the financial institution can restrict transactions that result in a savings transfer amount calculation to Automated Clearing House (ACH) transactions and check card transactions. Since a savings program results in a relatively predictable amount of savings to the financial institution, which is beneficial to the financial institution who can invest funds based on the holdings of its customers, the financial institution can apply savings advantages 232 to encourage customers to enroll benefitting customers as well. For the avoidance of doubt, where examples herein refer to check card transactions, any or all other types of electronic payments that a financial institution can handle can be substituted, including, but not limited to, online billpay transactions, mobile phone payments, debit card transactions, any type of recurring or automatic transaction taking place on a source account. In this regard, any banking transaction that involves the movement of money in or out of a source account can trigger the flexible automatic savings of the invention, whether an act that places more money into the source account or removes money from the source account.

As an example of an alternative financial transaction to which automatic savings of the invention can apply, when a debt holder consolidates debt across different debt instruments, usually a savings is realized by the debt holder on a monthly basis, for example, relative to status quo without consolidation where the debt holder is making separate payments. As a result, a savings amount is realized by the debt holder, e.g., on a periodic basis. However, often debt holders are the worst, from a statistical standpoint, at keeping the savings amount, either due to general financial distress requiring the savings amount, due to the same characteristic, e.g., gambling, retail therapy, etc. that caused initially caused debt to spiral. Accordingly, in one embodiment, a financial transaction that can be leveraged for achieving flexible automatic savings in accordance with the invention is a debt consolidation transaction, or periodic transactions. In this regard, the customer can elect to save all or a percentage of the savings amounts automatically based on the techniques described herein and existing financial infrastructure for handling debt consolidation transactions.

In other embodiments of the invention, no restrictions are placed on withdrawal from the transferee account, i.e., the savings amount in the account is available for withdrawal at any time. In accordance with another non-limiting embodiment of the invention, some outgoing transactions 228, such as withdrawal from bank teller personnel on account 220, can be prohibited by transactional restriction(s) 225 whereas other transactions 226, such as ATM withdrawal, are permitted, or vice versa. In another embodiment, outgoing financial transactions on the recipient account are blocked, except withdrawal. Similar to the case of permitting certain types of outgoing transactions 226 and prohibiting other types of outgoing transactions 228, optionally, certain types of incoming transactions 230 can also be permitted while prohibiting other types of incoming transactions 232. For a non-limiting example, $1 automatic savings transfers received by transferee savings account 220, as well as any recurring transfers set up, can be permitted on transferee savings account 220 while all others can be prohibited.

In another non-limiting aspect of the invention, the invention offers additional flexibility by allowing a customer to add a transfer relationship, or multiple transfer relationships, as part of an automatic savings program where at least one person or entity named on transferee accounts is in common with the source account for the transfer. Maintaining at least one common owner of the accounts advantageously results in greater trust over the transactions since the common owner can oversee that the payments are being correctly paid by accessing records associated with the transferee account and/or the source account.

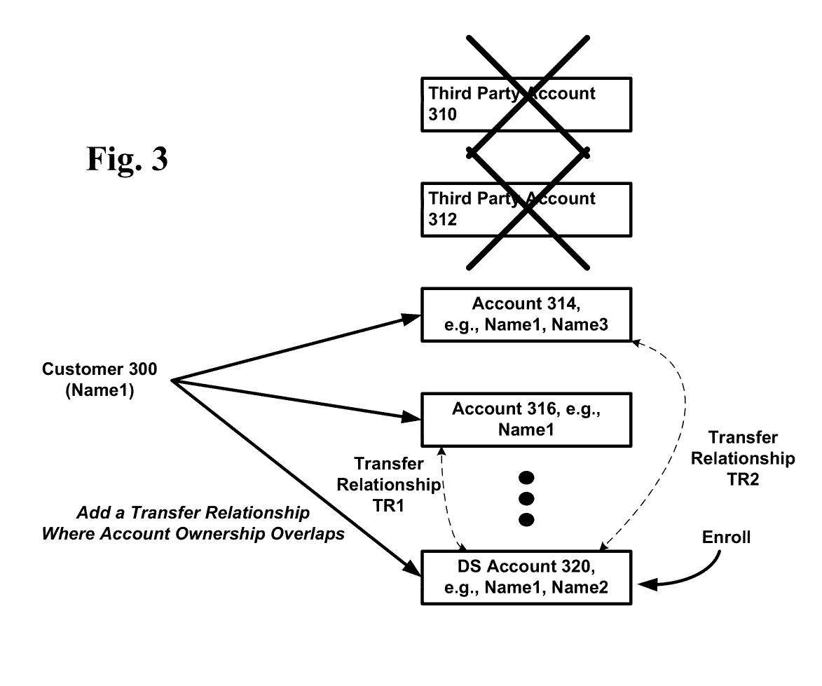

For instance, as shown in FIG. 3, a customer 300 having Name1 has a set of accounts, e.g., account 314 with Name1 and Name3 as co-owners of account 314, account 316 with only Name1 and a disciplined savings account 320 with Name1 and Name2 as co-owners. With the invention, since Name1 is on all three accounts, Name1 can set up a transfer relationship TR1 from account 316 to account 320, and similarly Name1 can set up a transfer relationship TR2 from account 314 to account 320 or another account. In one embodiment, the transfer relationships TR1 and TR2 of the invention are defined at enrollment. Since third party accounts 310, 312 do not include Name1 on the account, customer 300 cannot set up additional transfer relationships from or to accounts 310, 312.

Other exemplary aspects and embodiments of the flexible automatic savings programs in accordance with the invention will become apparent from the following detailed description of the invention.

### Flexible Automatic Savings Programs

As mentioned, today's automatic savings programs are not consumer friendly in that they are rigid in design and implementation, generally treating all customers the same when in fact very few customers are alike. Other programs require point of sale (POS) networks at merchant locations, and have other limitations as well, some of which are noted in the background. In consideration of these deficiencies in the state of the art, the invention provides an automatic and flexible way to save based on traditional bank transactions.

With the invention, enrollment into an automatic savings program is integrated with an account opening process and/or account maintenance process. Thus, consumers are provided with an automatic, easy, and simple way to save and grow balances based on their traditional banking transactions. Due to a decision point at the time of enrollment, rather than at the POS with every transaction, the automatic savings program of the invention is convenient and requires no change in consumer behavior at existing POS stations, e.g., POS devices at retail stores.

Consumers can also use their existing checking and savings accounts, and modify them to create a transfer relationship for automatic savings in accordance with the invention. The savings program of the invention can thus leverage existing and proven banking systems and transactions available within a financial institution. The excess funds are determined based on posted transactions and the account transfer from check to savings is initiated in a timely manner, e.g., once all transactions for a day have posted, based on funds availability. Advantageously, automatic savings programs of the invention are supported and controlled within a single and secure banking environment.

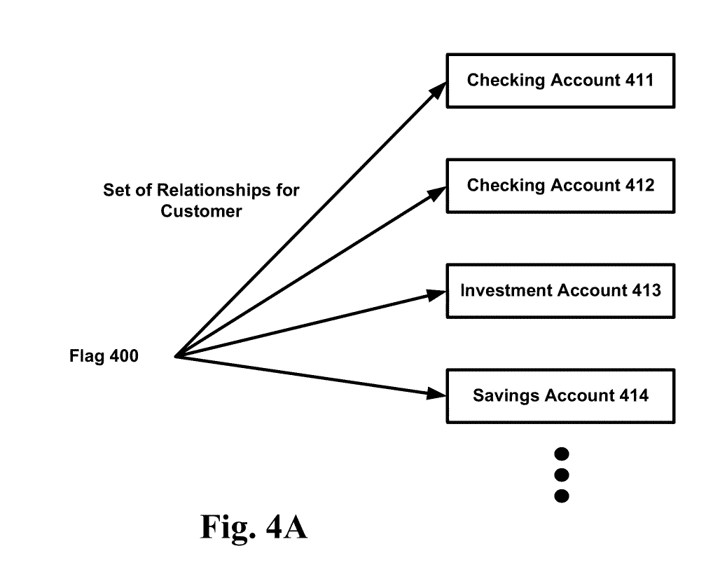

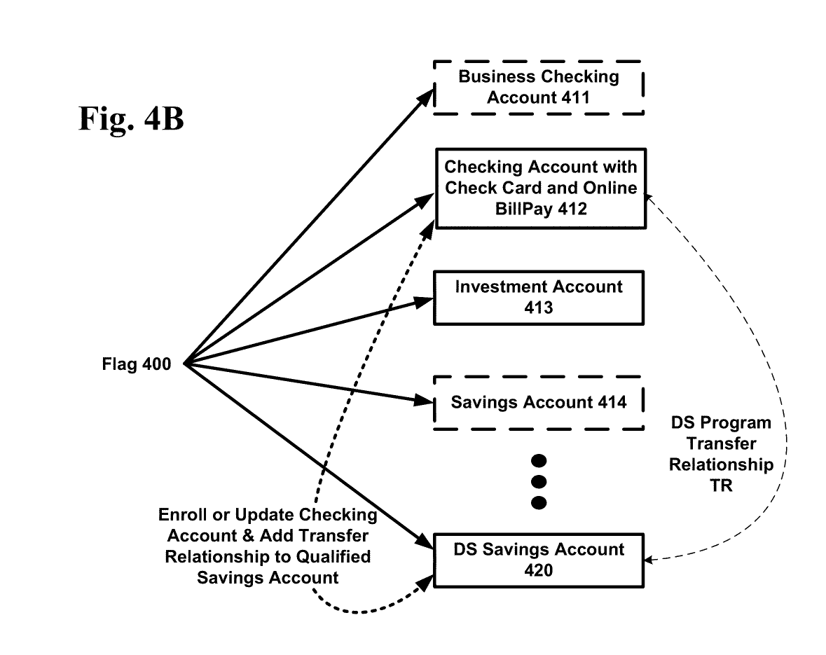

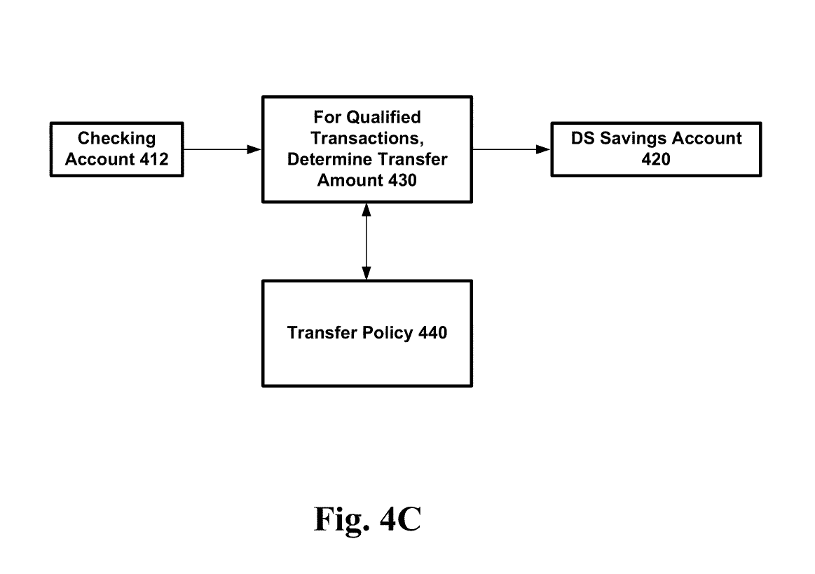

As shown in FIG. 4A, in one embodiment, a customer is given a flag 400 that ties a customer's accounts together. Flag 400 indicates a set of relationships to accounts 411, 412, 413, 414, etc., which can be different kinds of accounts, e.g., savings, checking, investment, etc. In one embodiment, a unique transfer trancode and description are used to identify transfer transactions for customer's checking and saving accounts.

As mentioned, for customer's checking and saving accounts that are participating in the proposed DS program, a unique transfer trancode/description is used to identify transfer transactions due to the DS program. FIG. 4B shows a checking account 412 for which a customer represented by flag 400 has enrolled in the DS program, or updated to reflect its status in the DS program, so that automatic savings are achieved in DS savings account 420. In this respect, only a subset of accounts qualify for a transfer relationship, e.g., a customer can enroll checking 412 into the program but not checking 411. Similarly, not all savings accounts are qualified to receive automatic savings, e.g., savings account 420 is qualified in the example as a new DS savings account, but investment account 413 and savings account 414 are not qualified DS savings accounts. Thus, no automatic transfer relationships can be set up for non-qualified savings accounts.

As further shown in FIG. 4B, at enrollment of accounts 412 and 420 to DS accounts, assuming a common ownership entity exists on both accounts, an automatic transfer relationship is formed, labeled TR in the diagram. A unique identifier is set for the transfer relationship, which the DS program automatically detects for each of the customer's transfer relationships, triggering the automatic savings for the customer according to DS program.

FIG. 4C illustrates carrying out transfer relationships, such as transfer relationship TR2 of FIG. 4B, between qualified or enrolled checking account(s) and qualified and enrolled savings account(s) defined when enrolling in a savings program in accordance with the invention. As shown, account 412 is a qualified checking account for which automatic transfers are to be assumed by the financial institution to qualified savings account 420 according to any of the embodiments of the automatic savings vehicles described herein. In this respect, at 430, for each transaction of checking 412, a transfer policy 440, selected by the customer at setup or enrollment in the automatic savings plan, is consulted to determine the transfer amount for transactions in checking 420 that qualify according to the transfer policy 430.

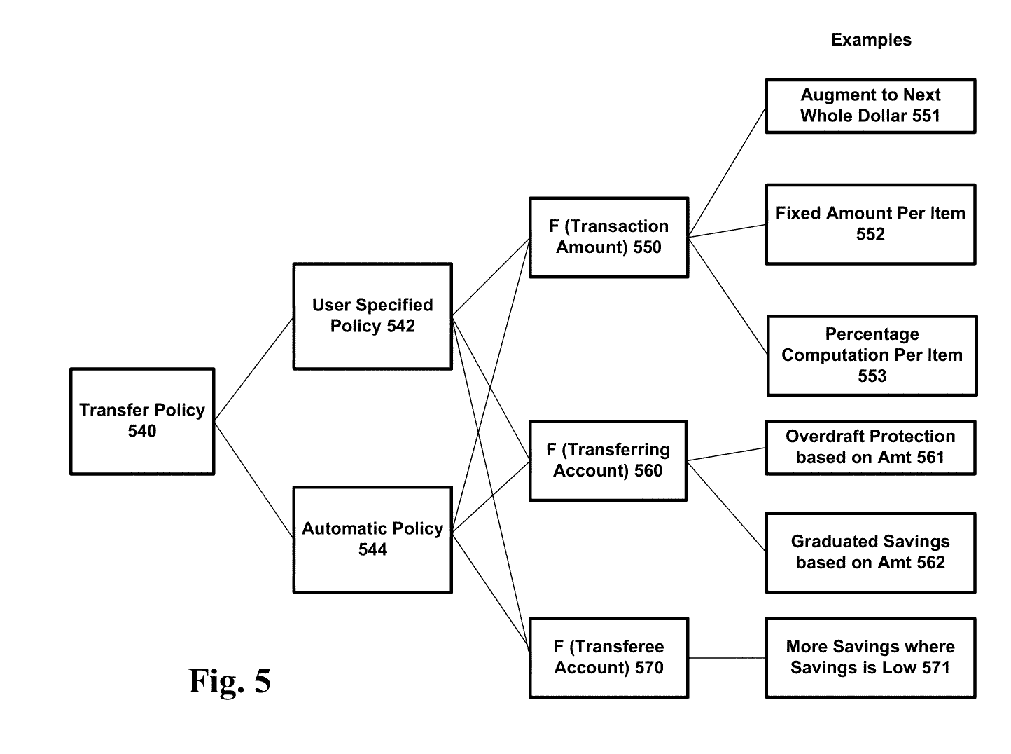

An exemplary, non-limiting categorization of a transfer policy 540 of an automatic savings transfer relationship of the invention is shown in FIG. 5. Transfer policy can include a user specified policy 542, i.e., savings policies and desires expressed by the customer and automatic policy 544, which includes policies that are enforced on the source and target accounts by the financial institution. An example of user specified policy 542 is selection of an option for determining savings amounts, e.g., fixed amount augmentation 552, percentage augmentation 553, augment to next whole dollar 551, etc. These three examples are also policies 550 that are a function of transaction amounts.

An example of automatic policy 544 implemented by the financial institution might be overdraft protection based on amount 561. Together with another example of applying a policy 562 that determines savings as graduated based on the amount in the source account (e.g., automatic savings shuts off when checking is less than $100, operates to transfer $1 per transaction when checking contains $100-$1000 and operates to transfer $5 per transaction when checking contains $1000+ dollars), these are policies 560 that are a function of the transferring or source account. In turn, an example of a policy 570 that is based on the transferee, recipient or target account is a policy 571 that operates to save more when a savings amount in the target savings account is low. Thus, the invention enables a rich and flexible set of policies that can be tailored to a customer and/or automatically enforced to place some limits on the flexibility as well.

As mentioned, where, in the past, a customer has had no choice except to enroll or not enroll in a predetermined savings program, the invention allows a customer to select from a set of options as to how savings can be implemented that are customized or customizable for the customer.

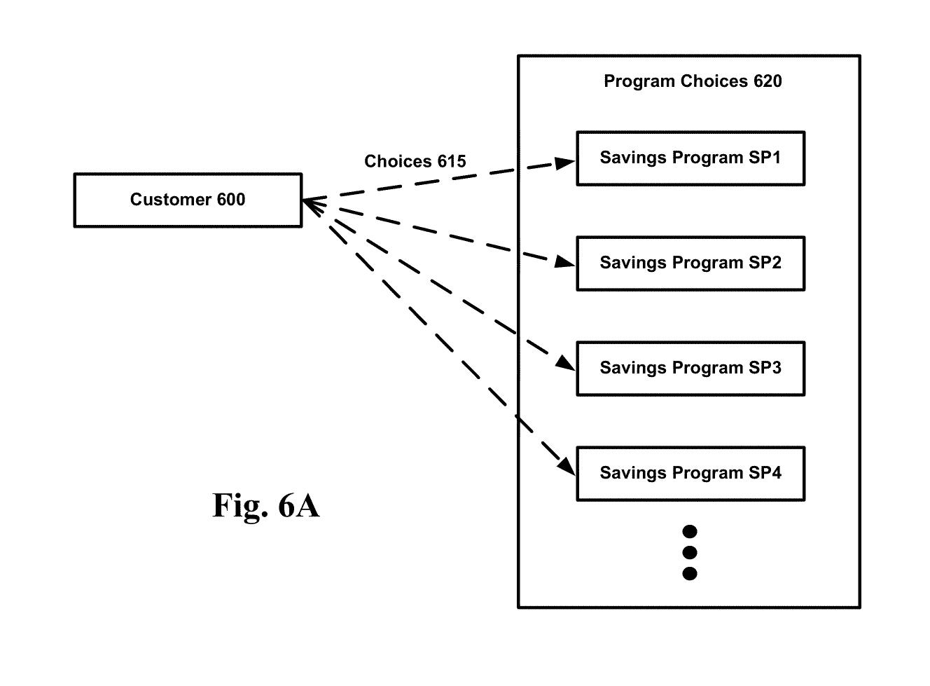

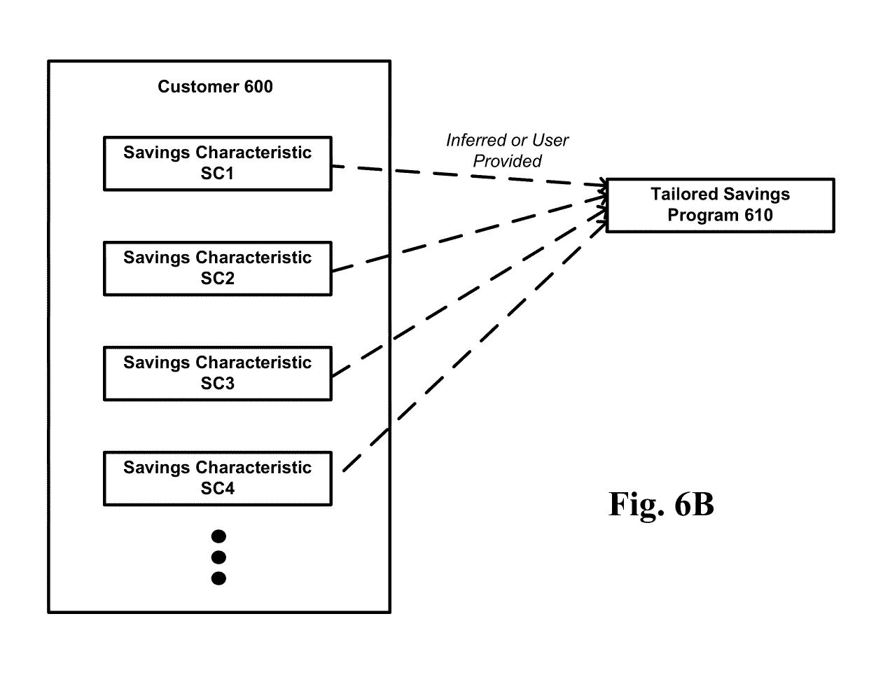

As shown in FIG. 6A, a customer 600 thus has several choices 615 of savings programs 620 including savings programs SP1, SP2, SP3, SP4, etc. The choices can be made directly by the customer 600 enrolling in the program, made indirectly via a wizard that helps determine a program for the customer 600, or automatically made by the financial institution based on knowledge of customer 600.

For instance, as a first example of a program choice 620, a customer can opt for a fixed amount/fee, e.g., $1.00, in increments per transaction, which makes reconciliation of the savings amount an easy computation. Other choices 620 can include round-up to the nearest dollar, e.g., $3.42 and $3.78 round up to $4.00 for $0.58 and $0.22 of savings, respectively, or a percent or other augmentation, e.g., at 10%, $3.50 augments to $3.85 and $35.00 augments to $38.50 for $0.35 and $3.50 of savings, respectively. Yet another choice 620 can be to pre-determine amounts by type of account, for example, add $1.00 to savings account and add 10% to investment account.

Yet another choice 620 can be to automatically determine a savings amount on top of transactions based on account holder characteristics known to the financial institution, e.g., number of transactions on average for the account holder per month. For instance, as shown in FIG. 6B, a customer 600 of a financial institution may have one or more inferred or customer-provided savings characteristics SC1, SC2, SC3, SC4, etc., which can be a basis for tailoring a savings program 610 to the customer 600 by analyzing and addressing each customer's savings needs.

Still another choice 620 can be to select a savings amount that achieves a savings goal for the customer. For example, a customer can set a goal of $50 per month of savings, and thus, savings are determined on that basis. For instance, if the customer makes 50 check card transactions, then each transaction has a $1 savings per transaction added. If the customer makes 5 check card transactions, then $10 savings per transaction is added. In this regard, the savings amount for a next day, next week, next month, etc. can be tailored based the number of transactions from the previous day, week, month, etc. to adjust the customer's savings level over time to a specific goal.

Accordingly, in one non-limiting aspect of the invention, customers are provided with an automatic savings program that is customized to their savings needs and goals. For instance, a consumer can explicitly choose a savings program from a set of different savings calculations. In addition, to help a consumer choose an automatic savings program that is appropriate for the consumer, a choice can be made for the consumer based on information about the consumer available to the financial institution. For example, the consumer can answer a set of questions about their savings goals and the like, or the financial institution can infer a set of savings goals tailored to the consumer based upon transactional history, demographic information or other statistical or customer information available about the consumer, e.g., amount of money in the checking account.

The invention offers a flexible transfer financial product for customers that automatically helps customers to save in a way that is tailored to the customers' needs, empowering the consumer to save more. Allowing selection from a set of choices, including an option to tune the amount of savings to be transferred dynamically, offers an incentive over the inflexible and non-integrated approaches of the past.

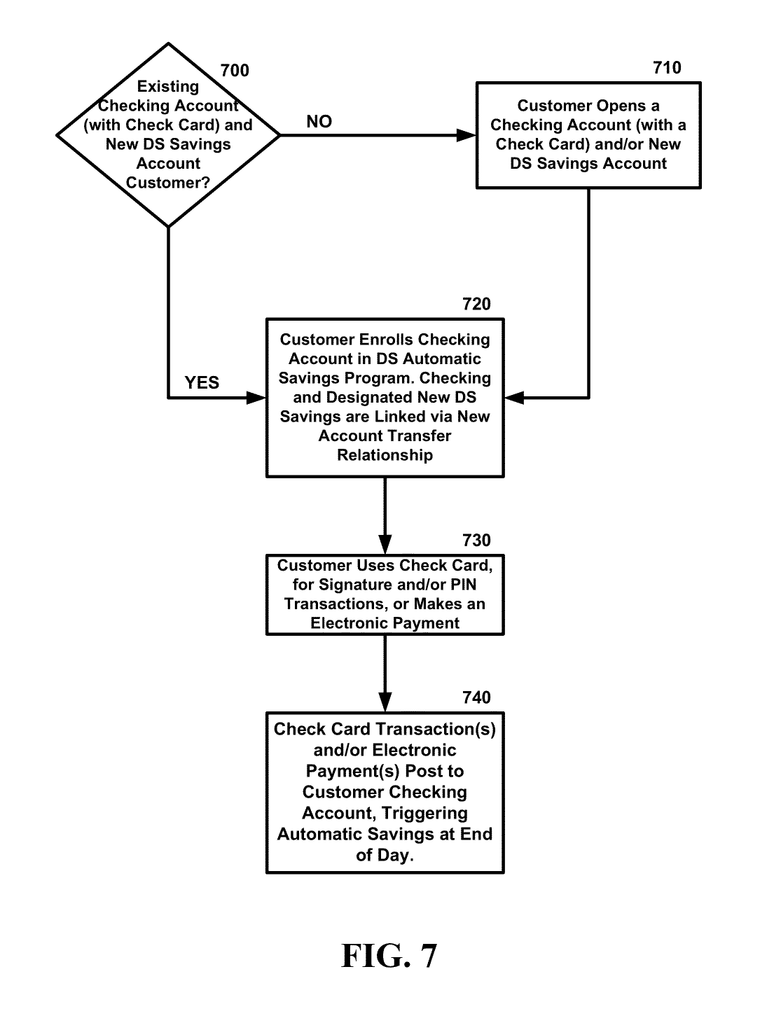

FIG. 7 is a flow diagram showing a representative flow for enrolling in an automatic savings program in accordance with the invention. At 700, the system checks whether there is an existing qualified type of checking account, e.g., checking account with check card, and qualified type of savings account. If not, at 710, the customer opens either a qualified type of checking account and/or a qualified type of savings account as the case may be. At 720, having a qualified checking and savings account, the customer enrolls in the automatic savings program, selecting or determining a savings amount, e.g., fixed amount per transaction, round up, percentage, augmentation calculation based on variables, etc. In addition, the automatic savings transfers are set up as part of an existing transfer infrastructure that allows a unique transaction code to apply to automatic savings transfers from the source to the target account(s) so that each of the transfers is identifiable as transfers of the automatic savings program. At 730, a customer makes an electronic payment for qualified types of transactions, e.g., online billpay or ACH debit transactions. At 740, the electronic payments post to the associated checking account and in turn, having accrued a set of qualified transactions for a given time period, e.g., a day, triggers the automated savings calculation and automatically transfers the savings amount to the target account(s).

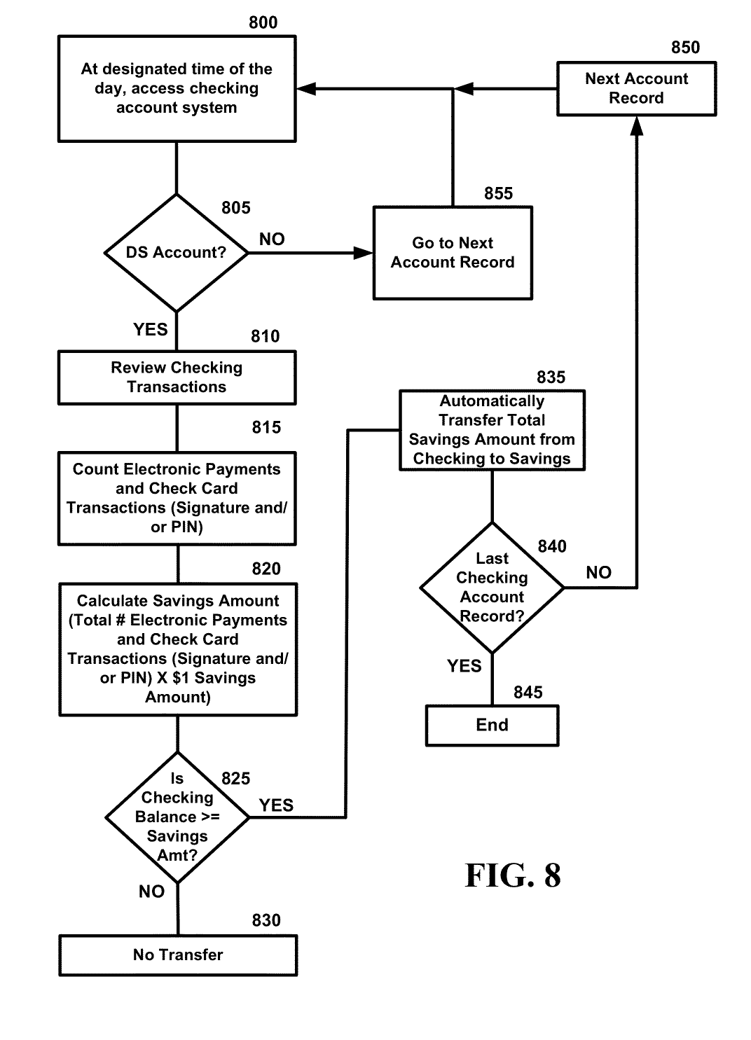

FIG. 8 below is a flow diagram generally showing an accounting of the transaction transfers for the proposed DS program. At 800, at a designated time, e.g., after postings for the day are all registered and accounted for, the checking system is accessed. This process is performed for all customers and checking accounts and is done at a time when transactions cannot be posted to the account. At 805, it is determined whether the account is a disciplined savings (DS) account. If not, there is no need to review the transactions and the flow moves to the next account record at 855, returning to 805 through access of the checking account system at 800. If the account is a DS savings account, then at 810, the checking transactions are reviewed. At 815, the number of qualified transactions are counted, i.e., the number of check card transactions (signature and/or PIN) and electronic payments.

At 820, the savings amount is calculated by multiplying $1 times the number of qualified transactions. However, the total savings amount for the transactions should not exceed a minimum checking balance at 825, or else the transaction will result in an overdraft. Accordingly, if such is the case, at 830, no transfer is made. If sufficient funds exist, then at 835, the total savings amount is transferred from checking to designated savings using existing Wachovia transfer infrastructure for transferring an amount from checking to savings. At 840, after all checking account records are finished review, the flow terminates at 845, or if not the last, continues to the next account record at 850 until all participating checking accounts have been reviewed and savings amounts totaled along with the initiation of a transfer of the totaled savings amounts for posting the next day.

In another non-limiting aspect of the invention, the invention offers additional flexibility by allowing a customer to add a transfer relationship, or multiple transfer relationships, as part of an automatic savings program as long as at least one person or entity named on the transferee account is in common with the source account for the transfer.

In one non-limiting implementation, for instance, a financial institution maintains a flag, or other identifier, for a customer that identifies each of the account relationships of the customer. The customer at enrollment then adds an appropriate transfer relationship to the other account relationships of the customer, where the transferee account includes at least one ownership entity, e.g., name, in common with the source checking account. In this regard, in further embodiments, transfers in accordance with an automatic savings program of the invention do not occur unless there is at least one common entity or person on the account. Requiring a common party on both accounts advantageously bolsters trust over the automatic transfers since the account holder can monitor whether and when the automatic transfers are made.

In one embodiment, the invention can be applied for any check card for which the customer is enrolled in an account at a financial institution implementing the invention. As a result, once the customer is enrolled according to any of the automatic savings choices of the invention, the customer is not required to input the savings amount at a POS station, since it is all handled automatically by the financial institution on the user's behalf.

Moreover, due to the automatic nature of the savings program, at a pre-specified time, e.g., once a day, all qualified transactions are processed to determine a savings amount that is transferred to the customer's account. The customer can also view a record of the transactions and the corresponding savings amount from each day, or interval. Since the customer is an entity on each affected account, the customer can view all affected accounts as part of banking statements, on-line views, and other electronic distribution of information. The savings amount can also be based on a pre-totaled amount from a relevant interval of transactions, e.g., determined from a sum of the savings amounts from all of the qualified transactions for a day.

As mentioned, due to the unique characteristics of an automatic savings account, i.e., restrictions on types of incoming and/or outgoing transactions, a premium interest rate can be applied to the transferee account in exchange for restrictions on deposits and/or withdrawals. Other examples of benefits that can be conferred on a transferee savings account include applying an annual bonus, e.g., for reaching a savings goal.

As part of a set of benefits applied to a transferee savings account in accordance with the invention, customers can be given some of the calculated savings amounts from the automatic savings program “for free,” e.g., for x months. For instance, the financial institution can provide some of the determined savings amounts on behalf of the customer, instead of the entire determined savings amount coming from the source financial account. In this respect, since some of the determined savings amounts are provided by the financial institution, e.g., a percentage, fixed amount, etc., this is different from a matching program, which supplements the savings of the determined savings amounts.

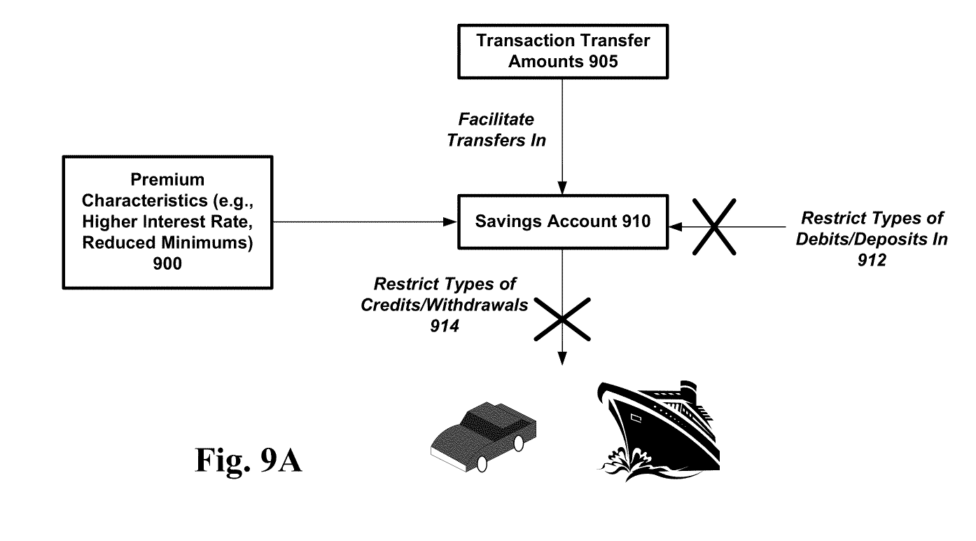

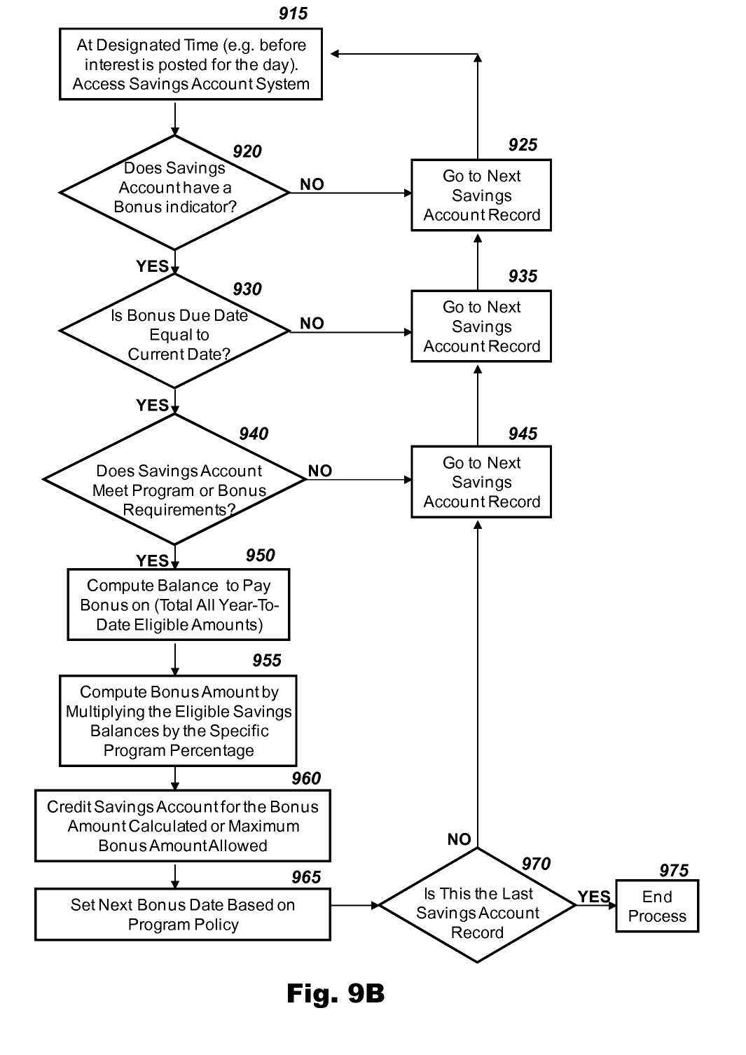

Accordingly, as shown in FIG. 9A, as an additional incentive beyond transferring transaction savings amounts 905 into a target savings account 910, premium characteristics 900, such as higher interest rate, reduced minimums, etc., can be applied to a target savings account 910 in accordance with the invention. Optionally, as shown by 912, certain types of debits/deposits can be excluded from the types of incoming transactions on savings account 910. As another option, as shown by 914, certain types of transactions like expensive consumer item purchases can be excluded from the types of outgoing transactions that may be conducted using savings account 910. Thus, the invention encourages the transfer of savings amounts per transactions in a way that is flexible and further facilitates consumers to save in the face of growing debt burden.

An exemplary non-limiting flow diagram for an optional bonus program that may be implemented by a financial institution is illustrated in FIG. 9B. In FIG. 9B, at 915, at a designated time, e.g., before interest is posted for the day, the savings account system is accessed by automatic savings software implemented by a financial institution. At 920, for each savings account, it is determined whether the bonus applies to the account by discovering the presence of a bonus indicator for the account. If the account is not an account to which the bonus applies, then at 925, the next record is retrieved and the flow returns to 915. If the savings account is a part of the bonus program, then at 930, it is determined whether the bonus due date is equal to the current date. In other words, it is determined if it is time to pay the bonus. If not, then at 935, the flow proceeds to the next savings account record and returns the flow to 915 to examine the next savings account record. If the bonus is due to the savings account on the given day, then at 940, it is determined whether the savings account meets any pre-defined criteria set for achieving the bonus. If not, then again at 945, the next savings account record is retrieved with the flow returning to 915.

If the savings account qualifies for bonus treatment on that day and meets the pre-defined criteria, then at 950, the balance is computed based on the total of eligible amounts saved in the automatic savings program for a given period (e.g., year-to-date total savings in the automatic savings program). Then, at 955, the bonus amount is further computed by multiplying the eligible savings balances by an applicable formula for determining the actual amount to be transferred to the consumer as a bonus, e.g., determined by a program percentage applied to the computed amount of 950. Then, at 960, the savings account is credited with the bonus amount calculated, optionally subject to a maximum bonus amount. At 965, the next bonus date is set based on program policy, e.g., the next year. Then, at 970, if all of the savings account records of the financial institution have been processed, then the process ends at 975. If more remain, then the flow returns to 915 for processing of additional records.

As mentioned, in one embodiment, check card transactions are rounded up using one of a set of rounding options and the round up amount is transferred to a savings or investment account with common ownership according to a customer's transfer relationships. As another example benefit and incentive to the customer enrolling in one of the financial institution's savings programs, a percentage of the transfer amount can be paid by the financial institution, e.g., deposits are made into a designated savings or investment account for the customer. The deposits by the financial institution can be made according to a set frequency: daily, weekly, monthly, annually or on an account anniversary date.

The invention can also include other limits on automatic savings. For instance, in one embodiment, for an overdraft or non-sufficient funds (OD/NSF) situation, the savings determination and transfer process is halted until a minimum balance is equal to or greater than the transfer amount.

The original transactions, e.g., check card transactions, either can post to the demand deposit account (DDA) as an original transaction amount accompanied by a separate transaction showing the savings amount determined for the transaction or can be reflected as a net figure, with details of the breakdown on request. Other transactions to which the automatic savings policy can be applied include, but not limited to, ACH transactions, online billpay transactions, and deposit transactions, etc.

As part of a benefits program for a customer enrolling in the banking program, or switching to the banking program from another bank, a bank can offer a bonus of X %, where X % can be up to 100%, of the dollars transfers for an initial time period, and Y % thereafter, where Y % is less than X %. Alternatively, the offer can be an annual bonus X %, where X % can be up to 100% of the dollars transfers and retained in the account. A limit can also be placed on a total bonus amount for a given time period, e.g., bonus of up to $300 a year.

A bank bonus program may also be applied to all or some of transfers to savings, e.g., applies to 100% of the transfers or a specific subset of transfers. For example, all $1 transfers and all scheduled transfers or only the $1 transfers resulting from eligible bank transactions up to $300 a year. The automatic savings program can apply to any new or existing consumer checking and savings product type, and can extend to investment savings account having different transactional restrictions. Since charging a monthly fee for maintaining an automatic savings account is counter to savings goals, the monthly fee that typically applies can be waived for the automatic savings programs of the invention. In one embodiment, ATM transactions and business check card products specifically are excluded from automatic savings accounts provided in accordance with the invention.

A savings account can also continue to earn interest as normal, or at a premium interest rate. Operation of the premium interest rate can be further limited by time, e.g., returning to normal after a pre-set period, or by a total savings amount in the account to which the premium interest rate is applied. Given the customer is named on both transferor and transferee accounts, existing transfer mechanisms can be used to actually make the transfer from account to account (e.g., once a day).

In one embodiment, a customer is only allowed to enroll in a preset number of automatic savings programs, e.g., a customer cannot set up more than three transfer relationships.

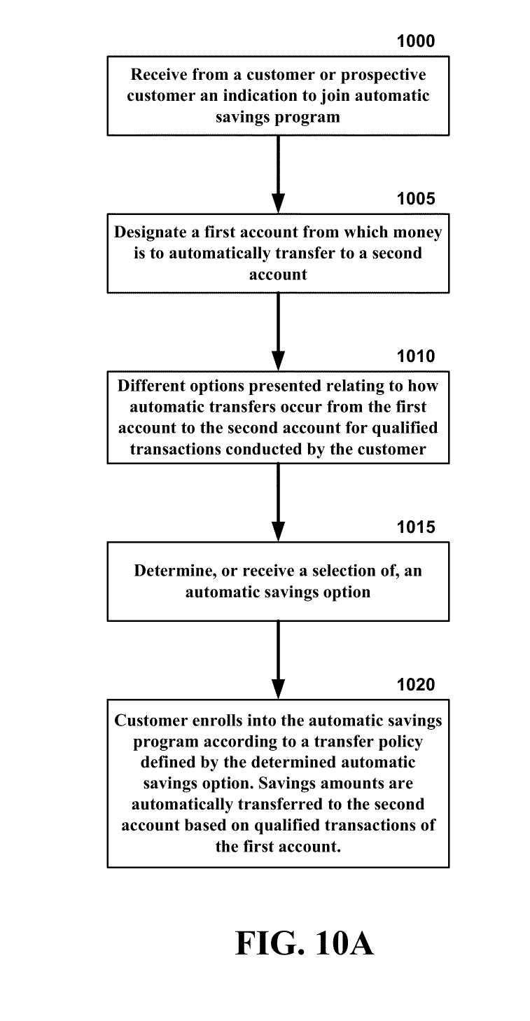

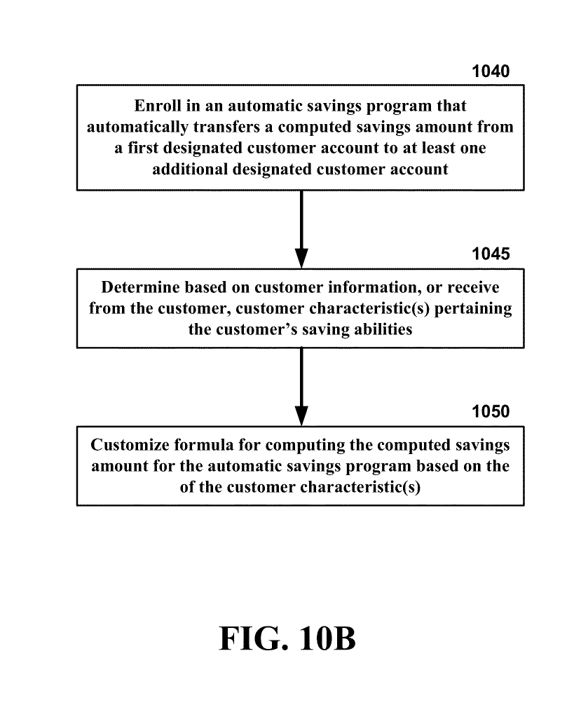

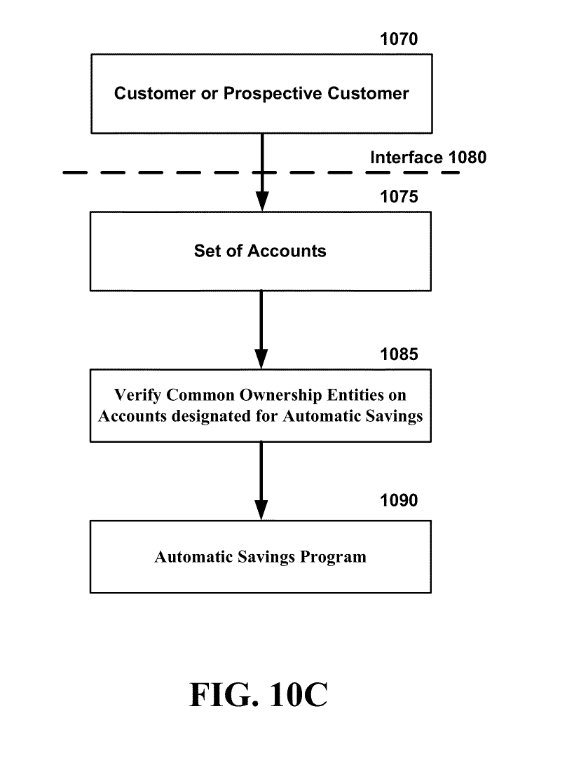

FIG. 10A is an exemplary flow diagram illustrating the flexibility of offering multiple automatic savings options in accordance with the invention. At 1000, a customer or prospective customer makes an indication to join the automatic savings program. At 1005, for qualified accounts, a first account from which money is to automatically transfer to a second account are selected for application to the automatic savings program. At 1010, the customer or prospective customer is presented with a set of different options relating to savings amounts that automatically transfer from the first account to the second account for qualified transactions conducted by the customer once enrolled in the automatic savings program. At 1015, an option is determined that suits the savings needs of the customer. At 1020, the customer enrolls in the automatic savings program according to a transfer policy, which can be partly user specified and partly automatically determined on the user's behalf.

FIG. 10B is another exemplary flow diagram illustrating a flexible process for enrolling in an automatic savings program that automatically transfers a computed savings amount from a first designated customer account to designated savings customer account(s) at 1040. At 1045, characteristic(s) of the customer pertaining to an ability to save are ascertained and at 1050, the formula for computing the computed savings amount is customized based on the characteristic(s).

FIG. 10C is a block diagram illustrating an interface 1080 for a prospective customer or a customer 1070 to interact with a set of accounts 1075 of a financial institution in accordance with an enrollment process of the invention. At 1085, common ownership of accounts to be enrolled is verified by checking overlap of ownership entities. Once common ownership is verified, the customer may enroll in the automatic savings program according to any of the embodiments of the invention at 1090.

Accordingly, as described herein in various non-limiting embodiments, the invention enhances system functionality that enables an automatic account transfer from checking to savings for each qualified transaction, e.g., electronic payments or check card transaction. A customer selects an option for automatic savings and/or the customer is aided in selecting an option for automatic savings, e.g., a fixed transfer amount/fee of $1.00 assessed for each electronic payment transactions. The system calculates a total transfer amount/fee for a given day based on posted electronic payment transactions, verifies funds availability for total daily transfer amount/fee and if funds are available, initiates transfer from checking to savings. No transfer will occur if funds are not available to cover the total daily transfer amount.

Accordingly, the invention enables automatic account transfers from checking to savings for one or more bank transaction types, e.g., check card, ATM, ACH, check, online billpay, etc. Additionally, the invention includes the ability to transfer a specific amount/fee according to options that can be set for each transaction type. For instance, a transfer amount/fee may be the difference between the transaction amount and the next whole dollar ($23.50 transaction rounded to $24.00=transfer amount/additional fee of $0.50) or a fixed dollar amount ($1.00, $2.00 etc.). For another example: a $1.00 additional fee/transfer amount can be applied to check card transactions and a $2.00 fee can be applied for online billpay transactions. Thus, savings programs can be varied by including one, all, or a combination of transaction type(s).

Program participation can also include an enrollment process and program having a defined transaction set including the ability to select transaction types from a list of eligible transactions. System calculates total transfer amount for a given day based on the eligible transactions, verify funds availability for total daily transfer amount and if funds are available initiate transfer from checking to savings. No transfer will occur if funds are not available to cover the total daily transfer amount.

As described in the various embodiments of an automatic savings program in accordance with the invention, a customer can enroll in the program as between source and target accounts where the customer is a common party on both accounts. To create a savings account for one's granddaughter, for example, a savings account in grandmother's name can be used as a transferee account and any otherwise qualified account with grandmother's name on the account can be used as the source for the transaction transfers. This way, grandmother can both benefit her granddaughter as well as oversee that the amounts being transferred.

In other embodiments, the present invention offers more flexible savings programs that dynamically tune savings characteristics of the accounts based on current information about the customer, e.g., an amount in account, based on user demographics, income changes, etc. so that the customer is always enrolled in a plan that helps the customer reach higher savings goals.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with implementing a flexible automatic savings program in accordance with the present invention.

The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for flexible automatic savings in accordance with the invention.

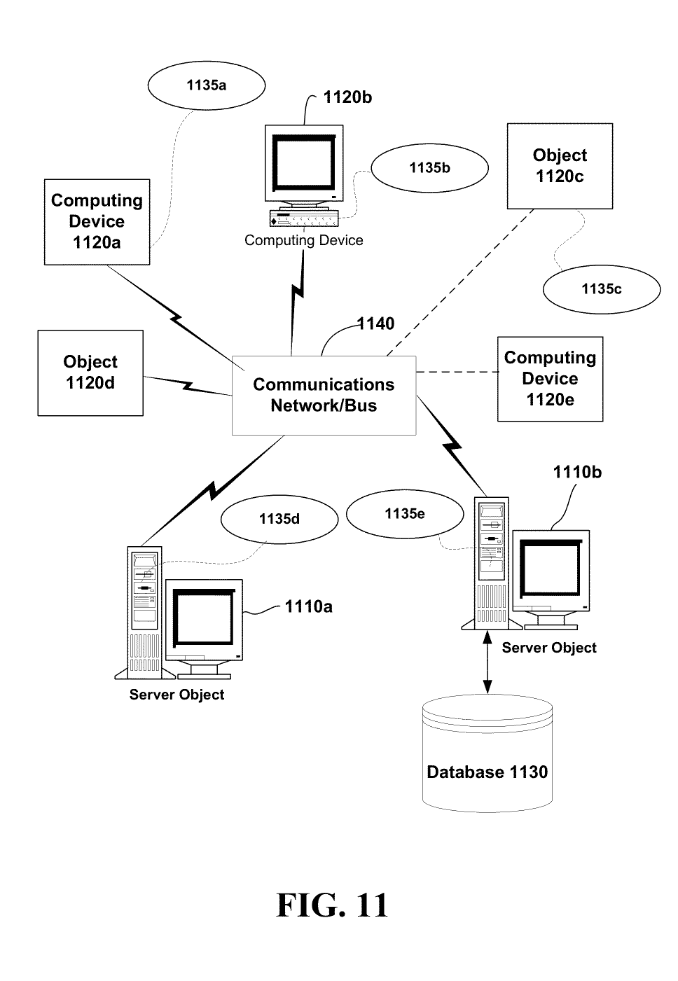

FIG. 11 provides a schematic diagram of an exemplary networked or distributed computing environment. The distributed computing environment comprises computing objects 1110a, 1110b, etc. and computing objects or devices 1120a, 1120b, 1120c, 1120d, 1120e, etc. These objects may comprise programs, methods, data stores, programmable logic, etc. The objects may comprise portions of the same or different devices such as laptops, PDAs, personal computers, servers, etc. Each object can communicate with another object by way of the communications network 1140. This network may itself comprise other computing objects and computing devices that provide services to the system of FIG. 11, and may itself represent multiple interconnected networks. In accordance with an aspect of the invention, each object 1110a, 1110b, etc. or 1120a, 1120b, 1120c, 1120d, 1120e, etc. may contain an application that might make use of an API, or other object, software, firmware and/or hardware, suitable for use with the flexible automated savings programs and/or processes in accordance with the invention.

It can also be appreciated that an object, such as 1120c, may be hosted on another computing device 1110a, 1110b, etc. or 1120a, 1120b, 1120c, 1120d, 1120e, etc. Thus, although the physical environment depicted may show the connected devices as computers, such illustration is merely exemplary and the physical environment may alternatively be depicted or described comprising various other digital devices, any of which may employ a variety of wired and wireless services, software objects such as interfaces, COM objects, and the like, in the network environment that may implicate the flexible automated savings processes of the invention.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to the flexible automated savings programs and/or processes of the present invention.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 11, as an example, computers 1120a, 1120b, 1120c, 1120d, 1120e, etc. can be thought of as clients and computers 1110a, 1110b, etc. can be thought of as servers where servers 1110a, 1110b, etc. maintain the data that is then replicated to client computers 1120a, 1120b, 1120c, 1120d, 1120e, etc., although any computer can be considered a client, a server, or both, depending on the circumstances. Any of these computing devices may be processing data or requesting services or tasks that may implicate the flexible automated savings programs and/or processes in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for the flexible automated savings programs and/or processes of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 11 illustrates an exemplary networked or distributed environment, with server(s) in communication with client computer (s) via a network/bus, in which the present invention may be employed. In more detail, a number of servers 1110a, 1110b, etc. are interconnected via a communications network/bus 1140, which may be a LAN, WAN, intranet, mobile device network, such as a Global Systems for Mobile (GSM) communication network, the Internet, etc., with a number of client or remote computing devices 1120a, 1120b, 1120c, 1120d, 1120e, etc., such as a portable computer, handheld computer, thin client, automatic teller machines (ATM) machine, banking kiosk, or other device that can interface to a financial institution, in accordance with the present invention. It is thus contemplated that the flexible automated savings programs and/or processes of the present invention may apply to any computing device.

In a network environment in which the communications network/bus 1140 is the Internet, for example, the servers 1110a, 1110b, etc. can be Web servers with which the clients 1120a, 1120b, 1120c, 1120d, 1120e, etc. communicate via any of a number of known protocols such as HTTP. Servers 1110a, 1110b, etc. may also serve as clients 1120a, 1120b, 1120c, 1120d, 1120e, etc., as may be characteristic of a distributed computing environment.

As mentioned, communications may be wired or wireless, or a combination, where appropriate. Client devices 1120a, 1120b, 1120c, 1120d, 1120e, etc. may or may not communicate via communications network/bus 1140, and may have independent communications associated therewith. Each client computer 1120a, 1120b, 1120c, 1120d, 1120e, etc. and server computer 1110a, 1110b, etc. may be equipped with various application program modules or objects 1135a, 1135b, 1135c, etc. and with connections or access to various types of storage elements or objects, across which files or data streams may be stored or to which portion(s) of files or data streams may be downloaded, transmitted or migrated. Any one or more of computers 1110a, 1110b, 1120a, 1120b, 1120c, 1120d, 1120e, etc. may be responsible for the maintenance and updating of a database 1130 or other storage element, such as a database or memory 1130 for storing data processed or amounts automatically saved according to the invention. Thus, the present invention can be utilized in a computer network environment having client computers 1120a, 1120b, 1120c, 1120d, 1120e, etc. that can access and interact with a computer network/bus 1140 and server computers 1110a, 1110b, etc. that may interact with client computers 1120a, 1120b, 1120c, 1120d, 1120e, etc. and other like devices, and databases 1130.

### Exemplary Computing Device

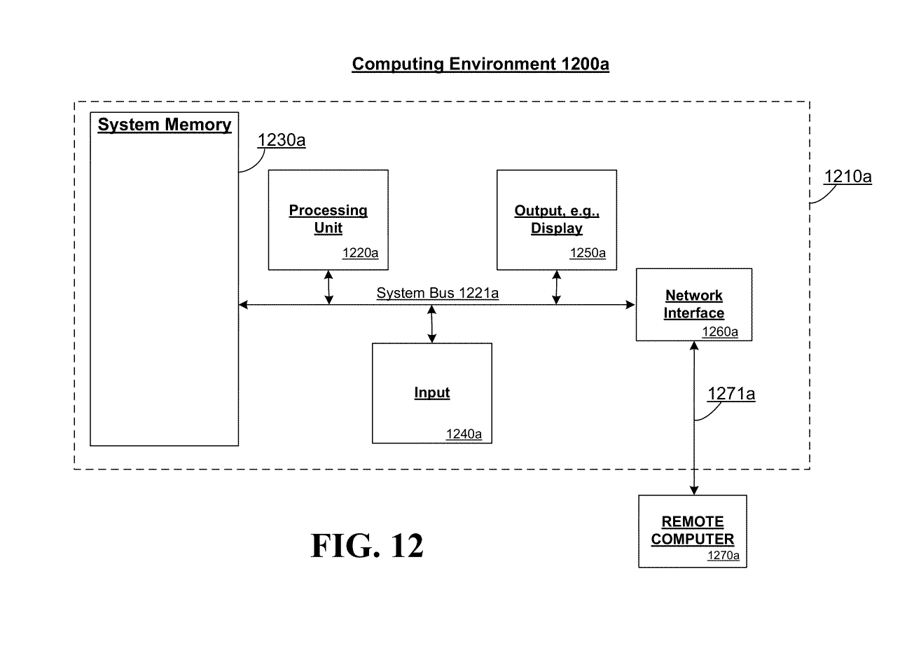

As mentioned, it should be understood that all types of computing devices and computing objects of all kinds are contemplated for use in connection with the present invention, i.e., anywhere that a device may carry out one or more aspects of software implementing a flexible automated savings program and/or processes for a financial institution, interface to a financial institution for transmitting transaction records or accessing account records, or otherwise receive, process or store data in connection with the same. Accordingly, the below general purpose remote computer described below in FIG. 12 is but one example, and the present invention may be implemented with any computer having network/bus interoperability and interaction with a financial institution accounts system.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 12 thus illustrates an example of a suitable computing system environment 1200a in which the invention may be implemented, although as made clear above, the computing system environment 1200a is only one example of a suitable computing environment for a device and is not intended to suggest any limitation as to the scope of use or functionality of the invention. Neither should the computing environment 1200a be interpreted as having any dependency or requirement relating to any one or combination of components illustrated in the exemplary operating environment 1200a.

With reference to FIG. 12, an exemplary device for implementing the invention includes a general purpose computing device in the form of a computer 1210a. Components of computer 1210a may include, but are not limited to, a processing unit 1220a, a system memory 1230a, and a system bus 1221a that couples various system components including the system memory to the processing unit 1220a. The system bus 1221a may be any of several types of bus structures including a memory bus or memory controller, a peripheral bus, and a local bus using any of a variety of bus architectures.

Computer 1210a typically includes a variety of computer readable media. Computer readable media can be any available media that can be accessed by computer 1210a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1210a. Communication media typically embodies computer readable instructions, data structures, program modules or other data in a modulated data signal such as a carrier wave or other transport mechanism and includes any information delivery media.

The system memory 1230a may include computer storage media in the form of volatile and/or nonvolatile memory such as read only memory (ROM) and/or random access memory (RAM). A basic input/output system (BIOS), containing the basic routines that help to transfer information between elements within computer 1210a, such as during start-up, may be stored in memory 1230a. Memory 1230a typically also contains data and/or program modules that are immediately accessible to and/or presently being operated on by processing unit 1220a. By way of example, and not limitation, memory 1230a may also include an operating system, application programs, other program modules, and program data.

The computer 1210a may also include other removable/non-removable, volatile/nonvolatile computer storage media. For example, computer 1210a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1221a through a non-removable memory interface such as an interface, and a magnetic disk drive or optical disk drive is typically connected to the system bus 1221a by a removable memory interface, such as an interface.

A user may enter commands and information into the computer 1210a through input devices such as a keyboard and pointing device, e.g., a mouse or touch pad. These and other input devices are often connected to the processing unit 1220a through user input 1240a and associated interface(s) that are coupled to the system bus 1221a, but may be connected by other interface and bus structures, such as a parallel port, game port or a universal serial bus (USB). A graphics subsystem may also be connected to the system bus 1221a. A monitor or other type of display device is also connected to the system bus 1221a via an interface, such as output interface 1250a, which may in turn communicate with video memory. In addition to a monitor, computers may also include other peripheral output devices such as speakers and a printer, which may be connected through output interface 1250a.

The computer 1210a may operate in a networked or distributed environment using logical connections to one or more other remote computers, such as remote computer 1270a, which may in turn have media capabilities different from device 1210a. The remote computer 1270a may be a personal computer, a server, a router, a network PC, a peer device or other common network node, or any other remote media consumption or transmission device, and may include any or all of the elements described above relative to the computer 1210a. The logical connections depicted in FIG. 12 include a network 1271a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1210a is connected to the LAN 1271a through a network interface or adapter. When used in a WAN networking environment, the computer 1210a typically includes a communications component, such as a modem, or other means for establishing communications over the WAN, such as the Internet. A communications component, such as a modem, which may be internal or external, may be connected to the system bus 1221a via the user input interface of input 1240a, or other appropriate mechanism. In a networked environment, program modules depicted relative to the computer 1210a, or portions thereof, may be stored in a remote memory storage device. It will be appreciated that the network connections shown and described are exemplary and other means of establishing a communications link between the computers may be used.

There are multiple ways of implementing the present invention, e.g., an appropriate API, tool kit, driver code, operating system, control, standalone or downloadable software object, etc., which enable applications and services to use the automatic savings programs and/or processes of the invention. The invention contemplates the use of the invention from the standpoint of an API (or other software object), as well as from a software or hardware object that carries out main functionality of the automatic savings programs and/or processes in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or network architecture for a financial institution. For instance, the automatic savings programs and/or processes of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the automatic savings programs and/or processes of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described, supra, methodologies that may be implemented in accordance with the disclosed subject matter will be better appreciated with reference to the flowcharts of figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms. Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network.

Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for enrolling in an automatic savings program offered by a financial institution, comprising:
receiving from a customer or prospective customer an indication to join the automatic savings program;
designating a first account from which money is to automatically transfer to a second account;
providing the customer or prospective customer with a set of different options relating to at least one savings amount that automatically transfers from the first account to the second account for future qualified transactions conducted by the customer once enrolled in the automatic savings program;
determining an option from the set of different options; and
enrolling the customer into the automatic savings program according to at least one transfer policy defined by the determined option that operates to automatically transfer savings amounts, based on transactions of the first account, to the second account.

2. The method of claim 1, wherein the determining includes determining an option of the set of different options based on at least one savings characteristic of the customer or prospective customer.

3. The method of claim 1, wherein the determining includes receiving a selection of an option from the set of different options from the customer or prospective customer.

4. The method of claim 1, wherein the determining includes determining an option from a set of different options for at least two different transaction types of transactions conducted with respect to the first account.

5. The method of claim 1, further comprising:
designating a subset of qualified transaction types on the first account for application of the automatic savings program; and
wherein the determining includes determining an option from a set of different options for the subset of qualified transaction types.

6. The method of claim 1, wherein the providing includes providing the customer or prospective customer with a set of options including at least two of: a fixed savings amount per qualified transaction of the first account, a percentage savings amount based on a percentage of a qualified transaction of the first account, a savings amount that rounds up each qualified transaction of the first account amount to the next whole dollar, a savings amount determined as a function of the balance of the first account, a savings amount determined as a function of a balance of the second account, or a savings amount determined based on a target total savings goal specified by the customer.

7. The method of claim 1, further comprising:
automatically transferring the savings amounts, based on transactions of the first account, to the second account according to the at least one transfer policy including user-specified transfer policy and automatic transfer policy.

8. A method for providing an automatic savings program by a financial institution, comprising:
enrolling in an automatic savings program that automatically transfers a computed savings amount from a first designated customer account to at least one additional designated customer account;
determining based on customer information, or receiving from the customer, at least one characteristic of the customer pertaining to an ability to save by the customer; and
customizing the automatic savings program to the at least one characteristic of the customer including customizing a formula for computing the computed savings amount.

9. The method according to claim 8, wherein the customizing includes customizing the automatic savings program based on customer savings characteristics or goals specified by the customer.

10. The method according to claim 8, wherein the customizing includes customizing the automatic savings program based on one or more of customer demographic information, customer personal, customer financial information, a customer risk profile, a current overall level of customer savings, a current or recent customer income or an aggregate savings goal.

11. The method according to claim 8, further comprising:
automatically transferring, according to the customized formula, the computed savings amount from the first designated customer account to the at least one additional designated customer account.

12. The method of claim 11, further comprising:
automatically preventing a transfer from overdrawing the first designated customer account.

13. The method of claim 11, further comprising:
wherein the transferring includes automatically transferring, according to the customized formula, the computed savings amount from the first designated customer account to the at least one additional designated customer account for each qualified transaction of the first designated customer account.

14. The method of claim 11, further comprising:
verifying funds availability for a daily total of computed savings amounts to ensure sufficient funds are available initiate a successful transfer from the first designated customer account to the at least one additional designated customer account.

15. The method of claim 11, wherein the customizing includes restricting transactions that result in a savings transfer amount computation to electronic transactions.

16. The method of claim 15, wherein the customizing includes restricting transactions that result in a savings transfer amount computation to one or more of Automated Clearing House (ACH) transactions, personal identification number (PIN) transactions, point of sale (POS) transactions, check card transactions, automated teller machine (ATM) transactions, mobile device transactions or online billpay transactions.

17. The method of claim 8, wherein the customizing includes providing an explicit benefit for the at least one additional customer account where the benefit is at an advantage over a corresponding benefit for a typical savings account without automatic savings.

18. The method of claim 17, wherein the customizing includes providing one or both of a higher interest rate than a typical savings interest rate for the at least one additional customer account or a bonus program whereby the financial institution assumes determines a bonus savings amount based on a total of savings amounts achieved by the customer in a time period.

19. A computing system for enrolling in an automatic savings program offered by a financial institution, comprising:
an interface for receiving an indication of assent from a customer or prospective customer to join the automatic savings program with respect to a first account from which savings amount are to transfer to at least one transferee account according to the terms of an automatic savings program; and
at least one processing component that determines at least one ownership entity of the first account and at least one ownership entity of the at least one transferee account and that enrolls the customer into the automatic savings program upon verifying at least one common ownership entity exists between the first account and the at least one transferee account.

20. The system of claim 19, wherein the interface receives, from the customer or prospective customer, a specification of a transfer relationship for each of the at least one transferee account.

21. The system of claim 19, wherein the at least one processing component assigns a unique transfer transaction code for each transfer of savings amount to identify transfer transactions.
